(19) United States
(12) Patent Application Publication
(10) Pub. No.: US 2026/0175273 A1
(43) Pub. Date: Jun. 25, 2026

(54) CLEANING DEVICE FOR A CONTAINER, IN PARTICULAR A BULK CONTAINER

(71) Applicant: UCON CONTAINER SYSTEM GMBH, Hausach (DE)

(72) Inventors: Ulrich LAUSTER, Schutterwald (DE); Ernst ALBACH, Hausach (DE); Javier TERÉS FLORES, Zell am Harmersbach (DE)

(21) Appl. No.: 19/427,912

(22) Filed: Dec. 19, 2025

(30) Foreign Application Priority Data
Dec. 20, 2024 (EP) 24 222274.3

(51) Int. Cl. B08B 9/08

(52) U.S. Cl. CPC B08B 9/0813; B08B 2203/0229

(57) ABSTRACT

The invention relates to a cleaning device (10) for a container (120), in particular a bulk container, with a feed pipe (20) having a feed pipe longitudinal axis (ZA), a first end (21) and a second end (22), and a wall (23) through which a cleaning medium can be guided, wherein at least two distribution pipes (30) are arranged on the feed pipe (20), each having a distribution pipe longitudinal axis (VA), a first end (31) and a second end (32) as well as a distribution pipe length (VL), each with its first end (31), wherein an outlet nozzle (37) is arranged at the second end (32) of each distribution pipe (30) and wherein each distribution pipe (30) is arranged to be movable relative to the feed pipe (20) between a folded position and an unfolded position by means of an adjustment mechanism (40).

The invention relates to a cleaning device for a container, in particular a bulk container.

Containers are known for storing and transporting liquid or free-flowing materials, which usually have an inlet opening in the upper side. Bulk containers are usually designed as containers with an integrated discharge funnel, at the tapered end of which an outlet with an outlet opening is arranged. The outlet funnel is usually oriented vertically downwards, so that when the outlet is open, bulk material can flow out of the bulk container through the outlet opening.

Basically, the problem of cleaning containers or bulk containers arises when material has become stuck to the inner wall of the container.

It is known to insert a rotating nozzle on a rod through the inlet opening. A cleaning medium can be sprayed onto the inner wall of the container through the nozzle. However, the problem is that, depending on the shape of the container, the inner wall cannot be cleaned uniformly in all regions. In particular, while the side wall of a circular cylindrical container can be cleaned with a uniform application of the cleaning medium, the bottom wall or lid wall are hardly accessible. With rectangular containers, the particular problem arises that the corners are not reliably cleaned due to the greater distance to the rotating nozzle.

The object of the invention is therefore to provide a cleaning device with which improved cleaning of the inner wall of a container can be enabled.

The object is achieved according to the invention by a cleaning device for containers with the features of claim 1.

Advantageous refinements and developments of the invention are specified in the dependent claims.

The cleaning device according to the invention for a container, in particular a bulk container, comprises a feed pipe having a feed pipe longitudinal axis, a first end and a second end through which a cleaning medium can be guided, wherein at least two distribution pipes, each having a distribution pipe longitudinal axis, a first end and a second end and a distribution pipe length, are arranged with their first end, wherein an outlet nozzle is arranged at the second end of each distribution pipe and wherein each distribution pipe is arranged to be movable relative to the feed pipe between a folded position and an unfolded position by means of an adjustment mechanism. The movement of the distribution pipes between the folded and unfolded positions makes it possible to insert the cleaning device into the container with the distribution pipes folded and to unfold the distribution pipes only inside the container. The cleaning medium can be guided through the feed pipe and the subsequent distribution pipes to the outlet nozzles, through which it exits and can be sprayed at the appropriate speed or pressure. In the unfolded position, the outlet nozzles located at the second ends of the distribution pipes can be brought closer to the inner wall of the container, thus enabling an improved cleaning effect. The use of at least two, preferably multiple, distribution pipes allows the cleaning medium to be sprayed in different directions.

Preferably, in the folded position, the distribution pipe is arranged essentially in contact with the wall of the feed pipe. This allows for the cleaning device to have the smallest possible outer diameter, so that the cleaning device can be easily inserted through an inlet opening into the interior of the container.

Preferably, in the unfolded position, the distribution pipe longitudinal axis is arranged at an angle between 10° and 180° to the feed pipe longitudinal axis. This allows on the one hand the outlet nozzle of the distribution pipe to be positioned at a desired distance from the inner wall of the container. On the other hand, angles between 10° and 30° can enable cleaning of the inside of the container lid surface, and angles between 150° and 180° can enable cleaning of the container bottom wall, in particular also the cleaning of an outlet funnel located in the container's bottom wall.

According to a particularly preferred embodiment of the invention, multiple distribution pipes, preferably four to forty distribution pipes, particularly preferably eight to forty distribution pipes, particularly preferably sixteen to forty distribution pipes, for example twenty-four distribution pipes, are arranged on the feed pipe. Such a number of distribution pipes enables good cleaning over the entire inner circumference of the container, especially without the need to rotate the cleaning device around the feed pipe longitudinal axis.

A particularly preferred embodiment of the invention provides that the distribution pipe length of at least two of the distribution pipes is different. This makes it possible to position the outlet nozzles at essentially the same distance from the inner wall, even if the container has an irregular cross-sectional shape. For example, if a container with a square or rectangular cross-section is to be cleaned, the distribution pipes that are oriented in the direction of the longitudinal edges of the container can be longer than the distribution pipes that are oriented perpendicular to the side surfaces of the container. In particular, by appropriately selecting the distribution pipe length, it can be achieved that, in the unfolded position of the distribution pipes, the outlet nozzles of the distribution pipes are arranged on the circumferential line of an imaginary square or rectangle. This makes it possible to position the outlet nozzles of the distribution pipes at essentially the same distance from the inner wall of the container, so that also a container with a non-circular cross-section can be cleaned uniformly over the entire inner wall.

Preferably, the adjustment mechanism is designed in the manner of an umbrella frame, which allows for a structurally simple design.

Advantageously, the adjustment mechanism comprises a slide arranged to be longitudinally displaceable on the feed pipe, on which a first end of a strut is articulated, wherein a second end of the strut is arranged on the distribution pipe to be displaceable along the distribution pipe longitudinal axis. Such a design allows for the simple swiveling of the distribution pipes. In particular, this makes it possible to arrange the struts of all distribution pipes on a single slide, which is arranged, for example, around the feed pipe, thus enabling all distribution pipes to be moved simultaneously in a simple way.

According to a preferred development of the invention, the outlet nozzle is arranged on the distribution pipe to be movable relative to the distribution pipe. This makes it possible, in particular, to align the outlet nozzle as well as possible, for example as perpendicularly as possible, relative to the wall to be cleaned, even at different angles of the distribution pipe relative to the wall to be cleaned, in order to further improve the cleaning effect. The movement of the outlet nozzle can, for example, be controlled electromechanically and in particular by a control unit of the cleaning device.

The cleaning medium is preferably a gas, in particular air, or a liquid, in particular water. Depending on the material to be cleaned, the appropriate cleaning medium can be selected, wherein of course appropriate cleaning additives are also conceivable, especially when using water as the cleaning medium. It is also conceivable that a first cleaning medium could be used in a first cleaning step and a second cleaning medium in a second cleaning step.

Advantageously, the cleaning device comprises a temperature control device for temperature control of the cleaning medium, which makes cleaning possible, for example, also with hot cleaning medium, especially hot water. It is also conceivable, for example, that in a first cleaning step cleaning with hot or cold water and in a second cleaning step drying with hot air could take place.

Preferably, the cleaning medium can be discharged in pulses through the outlet nozzles of the distribution pipes. In this way, a higher force can be achieved when the cleaning medium hits the wall of the container, thus increasing the cleaning effect. At the same time, the consumption of cleaning medium can be reduced.

An advantageous embodiment of the invention provides that each distribution pipe has a valve which is in particular electromechanically controllable. The valve can be used to open or close the distribution pipe, allowing or preventing the feed of cleaning medium, which, particularly with appropriate opening and closing times, enables a pulsed delivery of cleaning medium.

Preferably, the cleaning device comprises a control unit by means of which the valves can be controlled in such a way that at one time some of the valves are open and another part of the valves are closed, wherein in particular the valves are alternately open and closed. If only a portion of the valves, for example four out of twenty-four or eight out of forty, are open at any one time, while the remaining valves, i.e., the other part of the valves, are closed, the cleaning medium can escape from the few open distribution pipes at a higher pressure or speed than if all valves are open simultaneously. However, the alternating opening of the valves allows for cleaning across the entire circumference of the container. Assuming that the cleaning device comprises twenty-four distribution pipes numbered from 1 to 24, with valves. A control system such that, for example, in a first period the distribution pipes with the numbers 1, 7, 13 and 19 are open and all other distribution pipes are closed, in a subsequent second period the distribution pipes with the numbers 2, 8, 14 and 20 are open and all other distribution pipes are closed, in a subsequent third period the distribution pipes with the numbers 3, 9, 15 and 21 are open and all other distribution pipes are closed, and so on, can enable a kind of continuous circulating pulsed cleaning with a high cleaning effect.

An advantageous further development of the invention provides that the cleaning device has a housing and the feed pipe with the distribution pipes arranged thereon is arranged to be displaceable relative to the housing. The housing can, for example, be placed on the container and attached to it, thus enabling a defined positioning of the feed pipe and the distribution pipes after they have been inserted into the interior of the container.

In order to be able to also clean the cleaning device after the container has been cleaned, the cleaning device can have at least one, for example two, cleaning nozzles.

A cleaning station according to the invention, comprising a container mounted on a frame with an inlet opening and an integrated outlet funnel, at the tapered end of which an outlet with an outlet opening is arranged, has a cleaning device according to the invention which can be arranged at the inlet opening. This enables a defined positioning of the feed pipe and the distribution pipes after they have been inserted into the interior of the container.

Preferably, at least one mechanism for generating vibrations of the frame and/or at least one mechanism for generating impacts on the frame and/or the container is arranged on the frame. Such mechanisms can further improve the removal of contaminants from the inner wall of the container.

Advantageously, during a cleaning process, a suction device is arranged at the open outlet opening, which can improve the removal of the cleaning medium and the removed contaminants.

An exemplary embodiment of the invention will be described in greater detail with reference to the following figures. In the figures

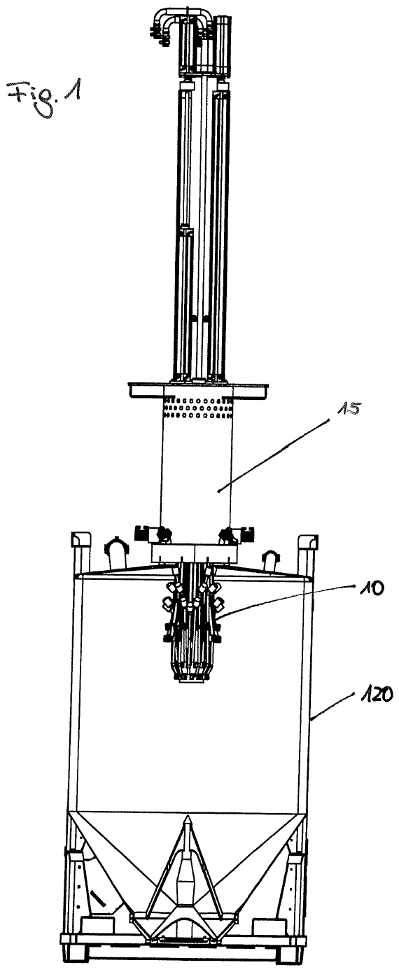

FIG. 1 shows a side view of an exemplary embodiment of a cleaning device according to the invention with multiple distribution pipes for containers, which is arranged on a container that is partially shown in section, wherein the distribution pipes are arranged in a folded position,

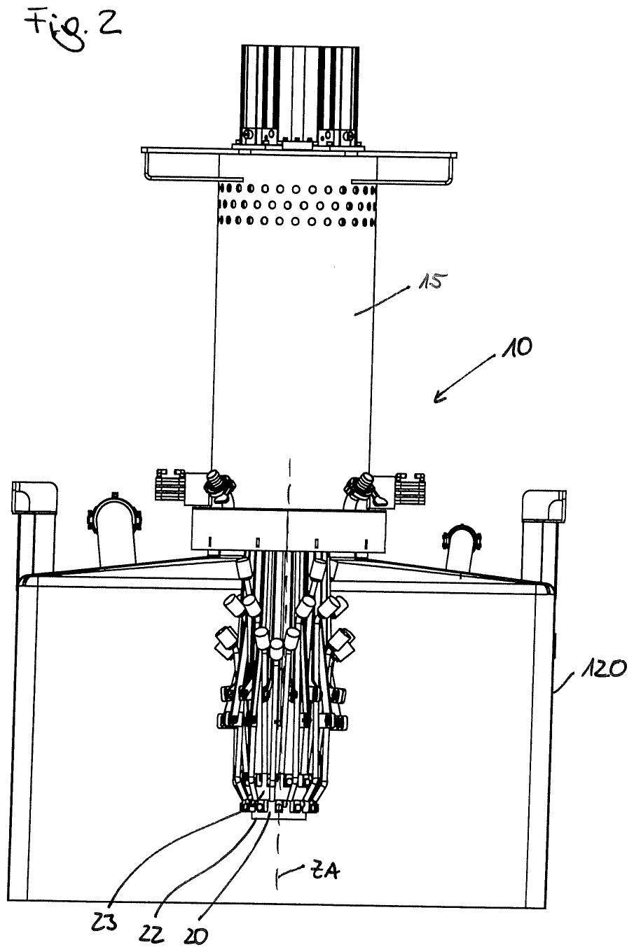

FIG. 2 shows an enlarged detail from FIG. 1,

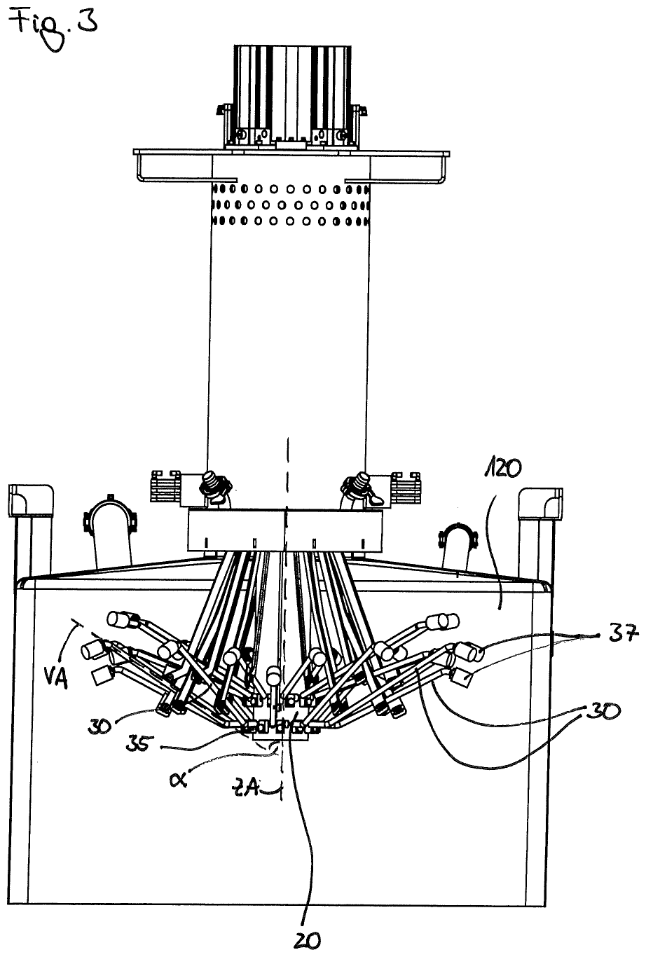

FIG. 3 shows the representation according to FIG. 2, wherein the distribution pipes are arranged in an unfolded position,

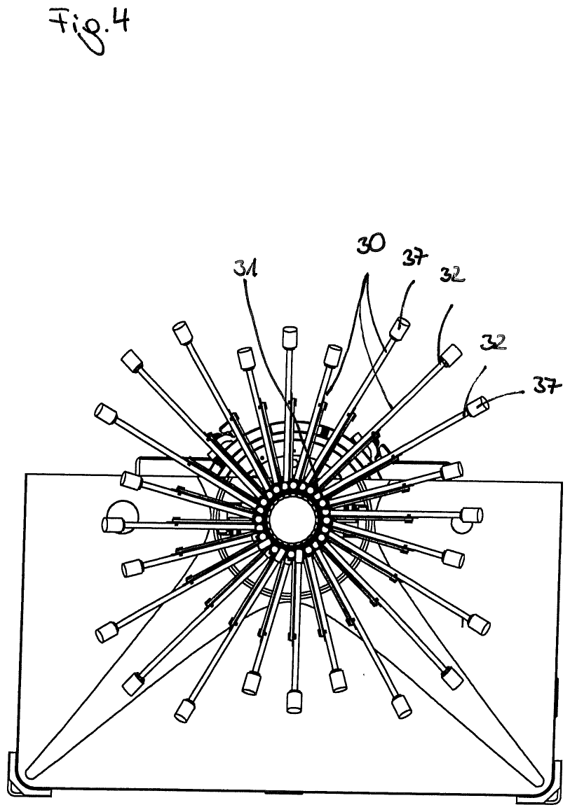

FIG. 4 shows a view from below of the cleaning device according to FIG. 3,

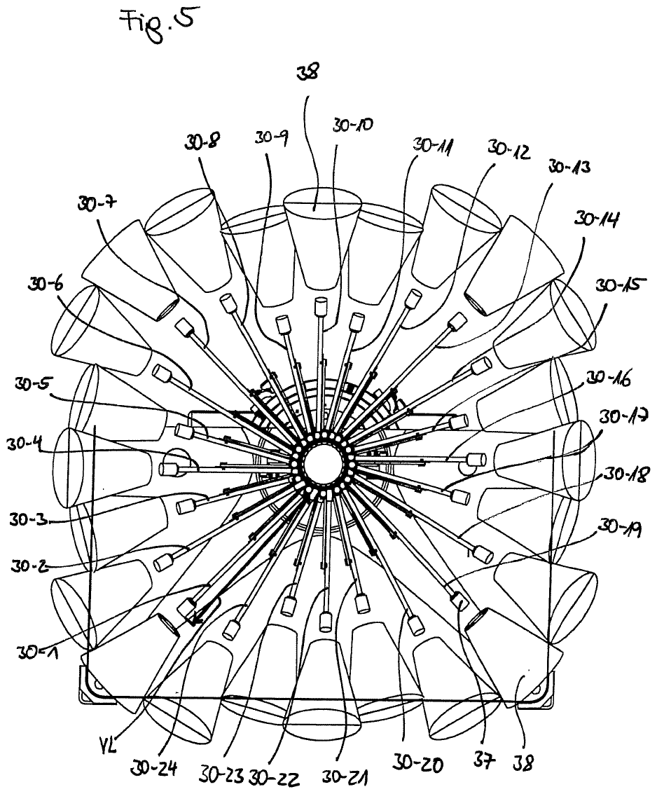

FIG. 5 shows the representation according to FIG. 4, in which the outlet cones of a cleaning medium are shown schematically,

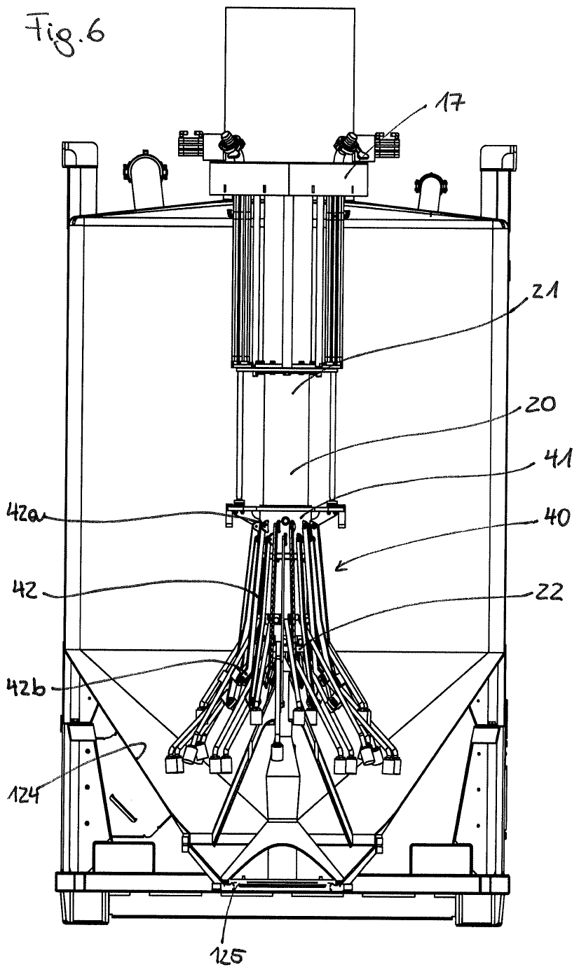

FIG. 6 shows an enlarged detail from FIG. 1, in which the cleaning device is further inserted into the container and the distribution pipes are arranged in a further unfolded position,

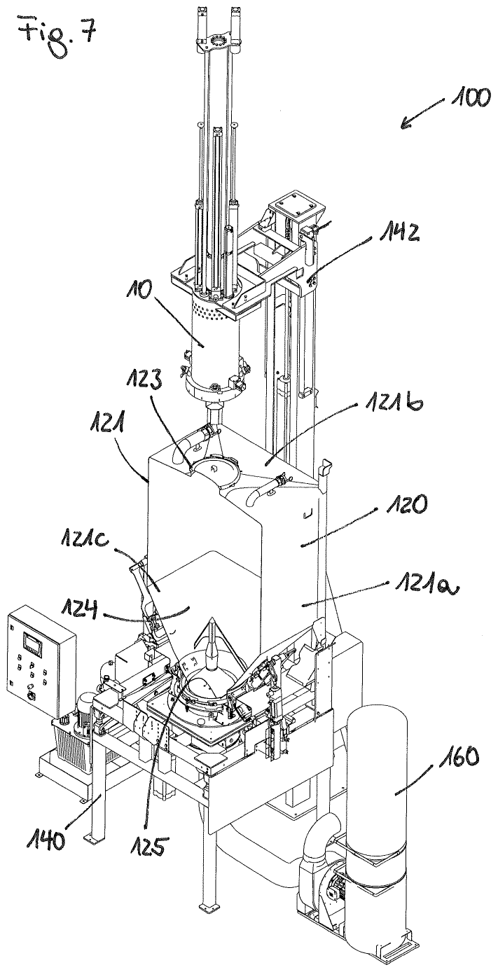

FIG. 7 shows a perspective view of an exemplary embodiment of a cleaning station with a container and a cleaning device according to FIG. 1, wherein the cleaning device is arranged above the container, and with a frame and a suction device,

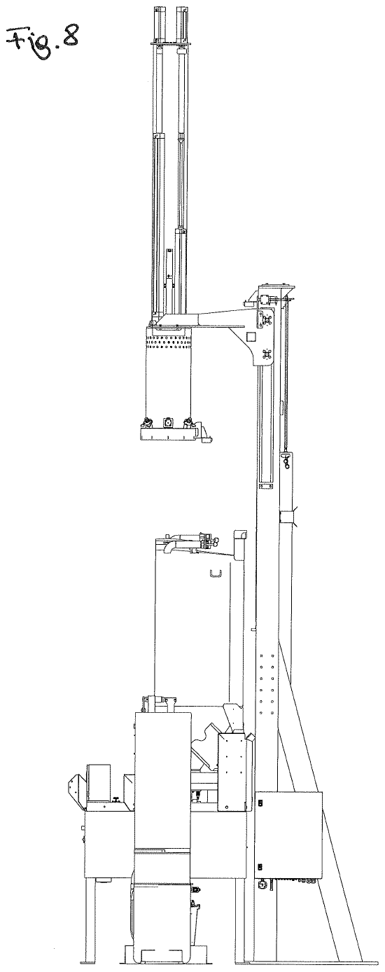

FIG. 8 shows a side view of the cleaning station according to FIG. 7,

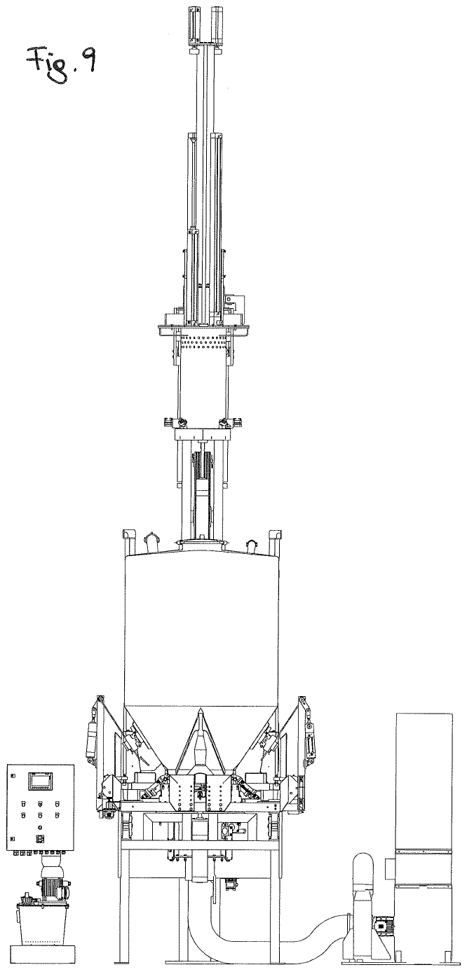

FIG. 9 shows a front view of the cleaning station according to FIG. 7, with the cleaning device mounted on the container.

FIGS. 1 to 9 show different views of an exemplary embodiment of a cleaning device 10 according to the invention for cleaning the interior of a container 100, wherein in FIGS. 7 to 9 a cleaning station 100 with the container 120, a frame 140 and a suction device 160 is additionally shown, and in FIGS. 1 to 6 the container 120 is additionally shown.

The container 120 can have at least one container 121 with a side wall 121a, a lid wall 121b and a bottom wall 121c, wherein an inlet opening 123 is arranged in the lid wall 121b. If the container 120 is designed as a bulk container, an outlet funnel 124 with an outlet opening 125 can be arranged in the bottom wall 121c.

The cleaning device 10 has a feed pipe 20 having a feed pipe longitudinal axis ZA, a first end 21 and a second end 22 and a wall 23. The feed pipe 20 can, for example, be made of metal. On the feed pipe 20, at least two distribution pipes 30 are arranged, each having a distribution pipe longitudinal axis VA, a first end 31 and a second end 32, and a distribution pipe length VL, each with its first end 31. The distribution pipes 30 are arranged particularly near the second end 22 of the feed pipe 20, for example in two circumferential rows. The distribution pipes 30 are in particular sealed at the first end 31, but are movably arranged on the feed pipe 20. Multiple distribution pipes 30, preferably four to forty distribution pipes 30, particularly preferably eight to forty distribution pipes 30, particularly preferably sixteen to forty distribution pipes 30, can be arranged on the feed pipe 20, in particular evenly distributed over the circumference of the feed pipe 20. In the present embodiment, twenty-four distribution pipes 30 are arranged on the feed pipe 20. As can be seen in FIG. 5, the individual distribution pipes 30 are numbered all around with 30-1, 30-2, 30-3, . . . 30-24, in order to be able to distinguish individual distribution pipes 30 in the following. When, in the following, reference is made generally to all distribution pipes 30, only the reference numeral 30 is used for the sake of clarity.

At the second end 32 of each distribution pipe 30 an outlet nozzle 37 is arranged. This can be arranged rigidly relative to the distribution pipe 30 or alternatively movably relative to the distribution pipe 30.

A cleaning medium can be conveyed through the cleaning device 10, in particular through the feed pipe 10 and the subsequent distribution pipes, which medium exits in particular through the outlet nozzles 37. Depending on the pressure and speed, the cleaning medium can be applied with great force to the inner wall of the container 120 in order to clean it. The cleaning medium exits the outlet nozzle 37, particularly in an outlet funnel 38. The cleaning medium is preferably a gas, in particular air, or a liquid, in particular water. When using air, compressed air is particularly preferable. A reservoir containing cleaning medium and the corresponding device for conveying the cleaning medium through the cleaning device 10 can be connected to the first end of the feed pipe 20. The cleaning device 10 can comprise a temperature control device for temperature-controlling the cleaning medium, in order to be able to use, for example, cold or hot cleaning medium for cleaning, depending on the requirements.

Each distribution pipe 30 is arranged to be movable relative to the feed pipe 20 between a folded-in position (see FIGS. 1 and 2) and an unfolded position (see FIG. 3 to 6) by means of an adjustment mechanism 40. In the folded position, the distribution pipe 30 is essentially located against the wall 23 of the feed pipe 20, or in other words, in the folded position the distribution pipe longitudinal axis VA is essentially parallel to the feed pipe longitudinal axis ZA (see FIGS. 1 and 2). Preferably, in the unfolded position, the distribution pipe longitudinal axis VA is arranged at an angle α between 10° and 180° to the feed pipe longitudinal axis ZA.

The cleaning device 10 can be easily inserted into the container 120 through the inlet opening 123 when the distribution pipes 30 are arranged in the folded position (see FIG. 1). In particular, a housing 15 of the cleaning device 10 can be arranged at the inlet opening 123. Subsequently, the feed pipe 20 with the distribution pipes 30 arranged on it can be moved relative to the housing 15, in particular lowered, and thus inserted into the container 120. The cleaning device 10 can be attached to the frame 140, to which the container 120 is also fixed, by means of a holding arm 142 and can initially be positioned above the container 120 (see FIGS. 7 and 8). To perform cleaning, the cleaning device 10 can be lowered until, in particular, its housing 15 is positioned at the inlet opening 123 (see FIG. 9). After inserting the cleaning device 10 into the container 120, the distribution pipes 30 can be unfolded (see FIG. 3 to 6).

The adjustment mechanism 40 can, for example, be designed in the manner of an umbrella frame. For example, the adjustment mechanism 40 may comprise a slide 41 arranged to be longitudinally displaceable on the feed pipe 20, on which a first end 42a of a strut 42 is articulated, wherein a second end 42b of the strut 42 is arranged on the distribution pipe 30 so as to be displaceable along the distribution pipe longitudinal axis VA (see in particular FIGS. 3 and 6). The slide 41 can be moved electromechanically along the feed pipe 20 in order to be able to move the distribution pipes 30 into the different positions.

As can be seen particularly in FIGS. 4 and 5, the distribution pipe lengths VL of at least two of the distribution pipes 30 can be different. For example, the distribution pipe length VL of the distribution pipe 30-1, which is oriented to one of the corners of the container 120, can be greater than the distribution pipe length LV of the distribution pipe 30-21, which is aligned substantially perpendicular to the side wall of the container 120 (see FIG. 5). By adjusting the distribution pipe lengths VL, the cleaning device 10 can be adapted to different cross-sectional shapes of the container 120 in order to achieve the best possible cleaning result for each type of container 120.

By adjusting the angle in the unfolded position, not only the side wall 121a of the container 120, but also the inside of the lid wall 121b and/or the bottom wall 121c can be cleaned better. At comparatively small angles α, for example in the range of 10° to 30°, the distribution pipes 30 are directed more towards the lid wall 121b after the cleaning device 10 has been inserted into the container 120. If the distribution pipes 30 are unfolded further, the side wall 121a can be cleaned (see FIG. 3). In addition, the cleaning device 10 can be lowered further into the container 120 in order to be able to clean the container 120 over its entire height. To clean the bottom wall 121c, the distribution pipes 30 are unfolded further, for example until the angle α is in the range of 150° to 180° (see FIG. 6). This enables good cleaning of the bottom wall 121c, but especially also of the inclined side surfaces of the outlet funnel 124 (see FIG. 6).

Material, for example bulk material, that has become stuck to the inner wall of the container 120 can be loosened by applying the cleaning medium and removed together with the cleaning medium through the outlet opening 125 of the container 120. For improved removal, the suction device 160 can be connected to the open outlet opening 125 of the container 120, with which material and cleaning medium can be extracted. The loosening of the material and thus the effectiveness of the cleaning can be further improved if at least one mechanism for generating vibrations of the frame 140 and/or at least one mechanism for generating impacts on the frame 140 and/or the container 120 is arranged on the frame 140 on which the container 120 is arranged.

It is possible to continuously dispense cleaning medium through each of the outlet nozzles 37 during the cleaning process. However, the required amount of cleaning medium and the energy required to operate the cleaning device 10 can be reduced if the cleaning medium can be discharged in pulses through the outlet nozzles 37 of the distribution pipes 30.

Each distribution pipe 30 can have a valve 35, which is particularly electromechanically controllable. The valve 35 can, for example, be located at the first end 31 of the distribution pipe 30. The valve 31 can be used to open or close the distribution pipe 30, allowing or preventing the feed of cleaning medium, which, particularly with appropriate opening and closing times, enables a pulsed delivery of cleaning medium.

The cleaning device 10 has a control unit by means of which the valves 35 can be controlled in such a way that at any given time some of the valves 35 and thus some of the distribution pipes 30 are open and other valves 35 and thus other distribution pipes 30 are closed, wherein in particular the valves 35 or distribution pipes 30 are alternately opened and closed. For example, the control unit can be configured such that in a first period, distribution pipes 30-1, 30-7, 30-13 and 30-19 are open and all other distribution pipes 30-2 to 30-6, 30-8 to 30-12, 30-14 to 30-18 and 30-20 to 30-24 are closed, in a subsequent second period, distribution pipes 30-2, 30-8, 30-14 and 30-20 are open and all other distribution pipes 30-1, 30-3 to 30-7, 30-9 to 30-13, 30-15 to 30-19 and 30-21 to 30-24 are closed and in a subsequent third period, distribution pipes 30-3, 30-9, 30-15 and 30-21 are closed and all other distribution pipes 30-1, 30-2, 30-4 to 30-8, 30-10 to 30-14, 30-16 to 30-20 and 30-22 to 30-24 are closed and so on, so that a kind of circulating pulsed cleaning with high cleaning effect can be enabled. The duration of each time period can be, for example, only a few seconds or less, such as just one tenth of a second.

The control unit can also be used to control the angle α at which the distribution pipes 30 are unfolded and how far the feed pipe 20 with the distribution pipes 30 arranged on it is extended from the housing 15 of the cleaning device 10 and thus how far it is inserted into the container 120, as well as, if necessary, the position in which the outlet nozzle 37 is arranged relative to the distribution pipe, in order to enable cleaning of as much of the inner wall of the container 120 as possible.

During a cleaning process, material and cleaning medium can be stirred up inside the container 120, which is not only removed from the container 120 through the outlet opening 125, but can also settle on the cleaning device 10 itself. In order to be able to also clean the cleaning device 10 after cleaning the container 120, the cleaning device 10 can have at least one, for example two, cleaning nozzles 17, which can be arranged, for example on the feed pipe 20 or on the adjustment mechanism 40, for example on the slide 41 which surrounds the feed pipe 20, in particular directed towards the distribution pipes 30. The cleaning nozzle 17 can, for example, be ring-shaped or ring-segment shaped. The cleaning nozzles 17 can each also have a valve which can be controlled in particular by the control unit in order to be able to open and close the cleaning nozzles 17 in a targeted manner in order to carry out a cleaning of the cleaning device 10.

### LIST OF REFERENCE NUMERALS

10 cleaning device
15 housing
17 cleaning nozzle
20 feed pipe
21 first end
22 second end
23 wall
30 distribution pipe
31 first end
32 second end
35 valve
37 outlet nozzle
38 outlet funnel
40 adjustment mechanism
41 slide
42 strut
42a first end
42b second end
100 cleaning station
120 container
121 container
121a wall
121b lid wall
121c bottom wall
123 inlet opening
124 outlet funnel
125 outlet opening
140 frame
142 holding arm
160 suction device
ZA feed pipe longitudinal axis
VA distribution pipe longitudinal axis
VL distribution pipe length
α angle

1. A cleaning device (10) for a container (120), in particular a bulk container, with a feed pipe (20) having a feed pipe longitudinal axis (ZA), a first end (21) and a second end (22), as well as a wall (23) through which a cleaning medium can be guided, wherein at least two distribution pipes (30) are arranged on the feed pipe (20), each having a distribution pipe longitudinal axis (VA), a first end (31) and a second end (32) as well as a distribution pipe length (VL), each with its first end (31), wherein an outlet nozzle (37) is arranged at the second end (32) of each distribution pipe (30) and wherein each distribution pipe (30) is arranged to be movable relative to the feed pipe (20) between a folded position and an unfolded position by means of an adjustment mechanism (40).

2. The cleaning device according to claim 1,
characterized in that, in the folded position, the distribution pipe (30) is arranged substantially resting against the wall (23) of the feed pipe (20).

3. The cleaning device according to claim 1,
characterized in that, in the unfolded position, the longitudinal axis (VA) of the distribution pipe is arranged at an angle (α) of between 10° and 180° to the longitudinal axis (ZA) of the feed pipe.

4. The cleaning device according to claim 1,
characterized in that multiple distribution pipes (30), preferably four to forty distribution pipes (30), particularly preferably eight to forty distribution pipes (30), particularly preferably sixteen to forty distribution pipes (30), for example twenty-four distribution pipes (30), are arranged on the feed pipe (20).

5. The cleaning device according to claim 1,
characterized in that the distribution pipe length (VL) of at least two of the distribution pipes (30) is different.

6. The cleaning device according to claim 1,
characterized in that the adjustment mechanism (40) comprises a slide (41) arranged to slide longitudinally on the feed pipe (20), on which a first end (42a) of a strut (42) is articulated, wherein a second end (42b) of the strut (42) is arranged on the distribution pipe (30) so as to be displaceable along the distribution pipe longitudinal axis (VA).

7. The cleaning device according to claim 1,
characterized in that the outlet nozzle (37) on the distribution pipe (30) is arranged to be displaceable relative to the distribution pipe (30).

8. The cleaning device according to claim 1,
characterized in that the cleaning medium is a gas, in particular air, or a liquid, in particular water.

9. The cleaning device according to claim 1,
characterized in that the cleaning device comprises a temperature control device for temperature control of the cleaning medium.

10. The cleaning device according to claim 1,
characterized in that the cleaning medium can be discharged through the outlet nozzles (37) of the distribution pipes (30) in a pulsed manner.

11. The cleaning device according to claim 1,
characterized in that each distribution pipe (30) has a valve (35) which is in particular electromechanically controllable.

12. The cleaning device according to claim 11,
characterized in that the cleaning device (10) comprises a control unit by means of which the valves (35) can be controlled in such a way that at any given time some of the valves (35) are open and some of the valves (35) are closed, wherein in particular the valves (35) are alternately open and closed.

13. The cleaning device according to claim 1,
characterized in that the cleaning device (10) has a housing (15) and the feed pipe (20) with the distribution pipes (30) arranged thereon is arranged to be displaceable relative to the housing (15).

14. A cleaning station (100) comprising a container (120) mounted on a frame (140) and having an inlet opening (123) and an integrated outlet funnel (124), at the tapered end of which an outlet with an outlet opening (125) is arranged, wherein a cleaning device (10) according to claim 1 can be arranged at the inlet opening (123).

15. The cleaning station according to claim 14,
characterized in that at least one mechanism for generating vibrations of the frame (140) and/or at least one mechanism for generating impacts on the frame (140) and/or the container (120) is arranged on the frame (140).

16. The cleaning station according to claim 14,
characterized in that a suction device (160) is arranged at the open outlet opening (125) during a cleaning process.
